(19) United States
(12) Patent Application Publication
(10) Pub. No.: US 2020/0025062 A1
(43) Pub. Date: Jan. 23, 2020

(54) OXY-HYDROGEN GAS FUEL SYSTEM

(71) Applicant: Ike Schuurman, Helmond (NL)

(72) Inventor: Ike Schuurman, Helmond (NL)

(21) Appl. No.: 16/041,870

(22) Filed: Jul. 23, 2018

(51) Int. Cl. F02B 43/10; F02M 21/02; F02D 41/00; C25B 1/04; C25B 9/06; C25B 15/02

(52) U.S. Cl. CPC F02B 43/10; F02M 21/0218; C25B 15/02; C25B 1/04; C25B 9/06; F02D 41/0027

(57) ABSTRACT

An oxy-hydrogen fuel system includes a fluid vessel partially filled with distilled water with graphene powder in the distilled water. A fluid pump is connected to the fluid vessel in a closed loop recirculation to recirculate the distilled water and suspend the graphene powder in the distilled water. A pair of electrodes located in the interior of the fluid vessel and submerged in the distilled water. An electrical power source is operatively connected to the pair of electrodes to generate oxy-hydrogen gas by electrolysis of the distilled water.

### FIELD OF THE INVENTION

The present invention generally relates to the production of oxy-hydrogen gas. More particularly, the present invention relates to an oxy-hydrogen gas fuel system for generating oxy-hydrogen gas by electrolysis of distilled water having suspended graphene powder.

### BACKGROUND OF THE INVENTION

Using hydrogen gas or oxy-hydrogen gas as an alternative fuel for internal combustion engines is desirable. Systems and methods for converting internal combustion engine vehicles to run on hydrogen gas or oxy-hydrogen gas are known.

One system includes storing compressed hydrogen gas in cylinders that are mounted to the vehicle from which the hydrogen gas is delivered to the combustion engine as fuel. While simple, this system has many drawbacks, including the inherent danger of transporting a large volume of compress hydrogen gas and refilling the cylinders once exhausted.

Another system uses electrolysis to split water into hydrogen and oxygen gas. There has been some development of using electrolysis to produce hydrogen gas or oxy-hydrogen gas on demand to fuel a combustion engine. One system is an “On-Demand Oxy-Hydrogen Fuel System” that is described in U.S. Published Patent Application 2017/0211516, the entirety of which is incorporated herein by reference. Another system is a “Hydrogen and Oxygen Gases, Produced on Demand by Electrolysis, as a Partial Hybrid Fuel Source for Internal Combustion Engines” described in U.S. Published Patent Application 2010/0181190, the entirety of which is incorporated herein by reference.

While these systems meet their respective objectives, there are drawbacks to using electrolysis of water to produce hydrogen and oxygen gas. Particularly, electrolysis of pure water is inefficient because it has a very low conductivity and high electrical voltage is required to split the water into hydrogen and oxygen gas. To reduce the low the voltage requirement, an electrolyte, such as a salt, an acid, or a base is added to the water to increase its electrical conductivity. However, these electrolytes are problematic because their use creates combustion emissions that may have undesirable components. This is primarily caused by the electrolytes bonding to the water and electrolysis of the water does not result in pure hydrogen and oxygen gas. Rather other components from the electrolytes are include in the product gases of the electrolysis and these components are entrained within the combustion exhaust.

Accordingly, because of the disadvantages existing in current systems, there is a need and a desire for an improved system for generating hydrogen gas and/or oxy-hydrogen gas for fueling internal combustion engines and, particularly, those of vehicles.

### SUMMARY OF THE INVENTION

The invention is directed toward an oxy-hydrogen fuel system for generating oxy-hydrogen gas on demand for fueling an internal combustion engine. In one aspect, the oxy-hydrogen fuel system includes a fluid vessel partially filled with distilled water with graphene powder in the distilled water. A fluid pump is connected to the fluid vessel in a closed loop recirculation to recirculate the distilled water and suspend the graphene powder in the distilled water. A pair of electrodes located in the interior of the fluid vessel and submerged in the distilled water. An electrical power source is operatively connected to the pair of electrodes to generate oxy-hydrogen gas by electrolysis of the distilled water.

This system overcomes drawbacks present in existing systems because it can produce oxy-hydrogen gas on demand for use by an internal combustion engine, thereby overcoming the problems with using hydrogen gas stored in cylinders. Additionally, since the system uses distilled water with suspended graphene, combustion emissions do not include harmful components that are otherwise emitted from combusting oxy-hydrogen that is produced by conventional electrolysis.

There has thus been outlined, rather broadly, the more key features of the invention in order that the detailed description thereof that follows may be better understood and in order that the present contribution to the art may be better appreciated.

Numerous objects, features, and advantages of the present invention will be apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in several ways. Also, it is to be understood that the phraseology and terminology employed herein are for descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is diagrammatic view of an oxy-hydrogen gas generating system in connection with a vehicle;

FIG. 2 is a diagrammatic view of an oxy-hydrogen gas generating system; and

FIG. 3 is a schematic of an oxy-hydrogen gas generating system in connection with an internal combustion engine and an electronic control unit of the engine.

### DETAILED DESCRIPTION OF THE INVENTION

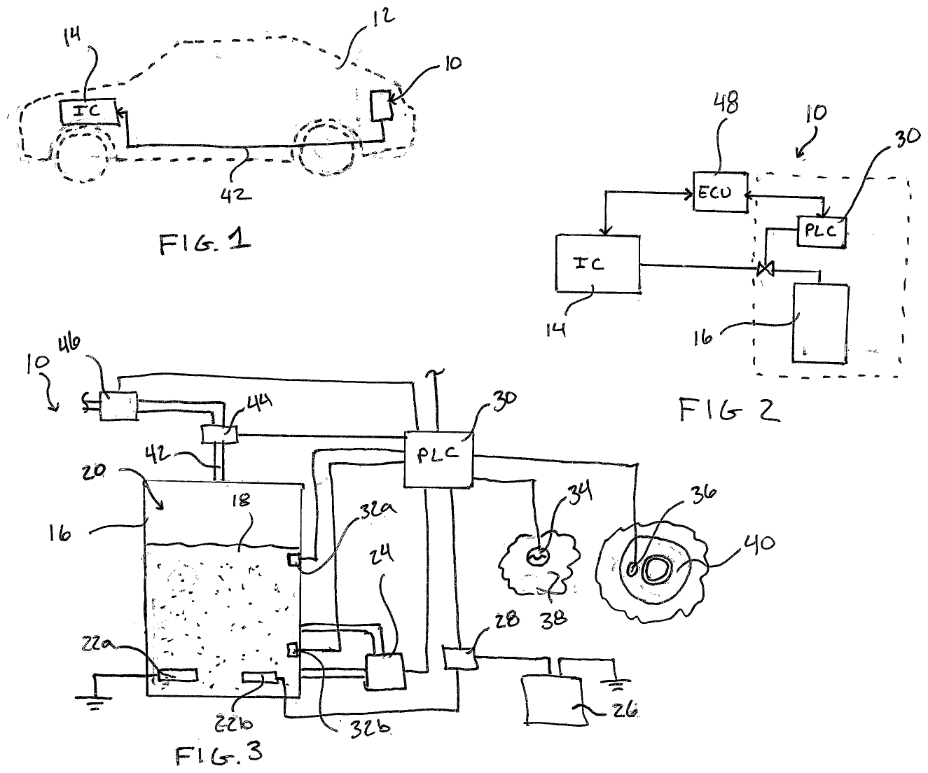

With reference to FIGS. 1 to 3, there is representatively illustrated an oxy-hydrogen gas generating system 10 constructed according to an embodiment of the invention. In FIG. 1, system 10 is shown installed in a vehicle 12, such as, for example, in the vehicle's trunk, and is connected to the vehicle's internal combustion engine 14 to delivery hydrogen gas, oxy-hydrogen gas, or a mixture of both, (hereinafter fuel gas), to the engine.

Turning to FIGS. 2 and 3, system 10 includes a fluid vessel 16. It is important to note that the fluid vessel 16 is only diagrammatically represented and may take on various forms. For example, the interior of the vessel may be divided into two or more compartment or chambers that may or may not be sealed from one another. Further, one of skilled in the art will appreciate that the vessel could have various shapes and is not limited to the rectangular configuration that is representatively shown.

The fluid vessel 16 contains distilled water 18 and is only partially filed to allow a space 20 between the water and the top of the vessel to accommodate produced fuel gas. As discussed above, distilled water has a low electrical conductivity. An important aspect of the invention is to suspend graphene powder within the distilled water to provide electrically conductivity to the distilled water. An advantage of using graphene powder over conventional electrolytes is that the graphene does not bond with the water. Because graphene does not bond with water and because the water is distilled, only pure hydrogen gas and oxygen gas is produced during electrolysis. The advantage of this being that the product of combustion is water vapor free of any undesirable contaminants.

With continued reference to the FIGS. 2 and 3, a circulation pump 24 is connected to the vessel 16 and operates to circulate water 18 to suspend the graphene in the water. Electrodes 22a and 22b are disposed in the interior of the vessel at a spaced apart distance and are submerged in the water 18. Preferably the electrodes are located toward the bottom of the vessel 16 to prevent contact with the fuel gas. A power source 26, such as an electrical battery or alternator is operatively connected to the electrodes 22a and 22b via a switch 28. Switch 28 is operated to conduct electricity from the power source 26 to the electrodes 22a and 22b to cause electrolysis of water 18 having graphene particles suspended therein. In some instances, the original alternator of a vehicle may be replaced with an alternator having a higher amperage to increase electrical power to the electrodes.

A programmable logic controller (PLC) 30 may be operatively connected to the pump 24 and the switch 28 and include programmed instructions to operate the pump and switch according to a desired control logic to produce fuel gas on demand through electrolysis of water 18. One or more fluid level sensors 32a and 32b may be provided to detect a level of water 18 within the vessel 16. The sensors 32a and 32 may operatively connected to the PLC 30, which operates to illuminate one or more indicator lights 34 and 36 to indicate the detected water level within the vessel 16.

Representatively, lights 34 and 36 can be multicolor LED and be illuminated in different colors to indicate the detected water level. For instance, a green light could indicate the vessel is full, a yellow light could indicate the vessel is not full, but also not empty, and a red light could indicate that the vessel is empty and needs to be refilled with distilled water 18. As shown, light 34 could be located on the dashboard 38 of a vehicle and light 36 could be located near a refill valve/neck 40. While not shown, the refill neck 40 is fluidically connected to the vessel 16 to refill the vessel. A one-way valve may be installed in this fluidic connection.

The vessel 16 is connected, preferably toward its top, to a gas line 42, which can be connected to an internal combustion engine to provide fuel gas from the vessel to the engine. A valve 44 may be disposed across the gas line 42 and operated to control the flow of fuel gas from the vessel 16 and through the gas line. Valve 44 may be operatively connected to the PLC 30, which operates to control opening and closing the valve. Additionally, a pump 46 may be connect to the gas line 42 and operated to pump fuel gas from the vessel 16 and through the gas line. The pump 46 may be operatively connected to the PLC 30, which operates to turn the pump 46 off and on.

As further shown, in the representative embodiment, the PLC 30 may be operatively connected to the electronic control unit 48 of an internal combustion engine 14. This is particularly useful if the engine is electronically controlled so that the volume and rate of fuel gas delivered to the engine from the vessel 16 is controlled to maintain a stochiometric combustion.

While not shown, in embodiments, a heater may be provided to ensure that the water 18 does not freeze. The heater can be controlled via the PLC 30 by a temperature sensor that operates to detect the ambient temperature and when the temperature falls below a setpoint, the PLC can turn the heater on.

In embodiments, system 10 can be used to provide hydrogen gas or oxy-hydrogen gas to an internal combustion engine as a fuel supplement. However, preferably, in a vehicle application, the vehicle is converted to run entirely on the oxy-hydrogen gas produced by the system 10. As part of this conversion, the conventional fuel tank, fuel pump, and fuel line may be removed or prevented from operating. Additionally, the air intake may be connected to line 44 and sealed against intaking ambient air and the fuel injector ports may be sealed.

Also, while not shown, an electrical plug may be provided that may be located behind the fuel door to connect a power cord to recharge the power source 26 if the power source is a battery and requires charging. Further, it will be apparent to one skilled in the art that additional safety features may be provided that prevent a flow of fuel gas if there is a vehicle collision.

Several embodiments of the invention have been described. Nevertheless, it will be understood that various modifications may be made without departing from the spirit and scope of the invention. Accordingly, other embodiments are within the scope of the following claims.

1. An oxy-hydrogen gas generating fuel system for use by an internal combustion engine, the gas generator comprising:
a fluid vessel partially filled with distilled water;
graphene powder in the distilled water;
a fluid pump connected to the fluid vessel in a closed loop recirculation to recirculate the distilled water and suspend the graphene powder in the distilled water;
a pair of electrodes in the interior of the fluid vessel and submerged in the distilled water; and
an electrical power source operatively connected to the pair of electrodes to cause electrolysis of the water.

2. The oxy-hydrogen fuel system of claim 1, further comprising a liquid level sensor configured to detect a level of the distilled water in the fluid vessel.

3. The oxy-hydrogen fuel system of claim 1, further comprising an indicator light configured to indicate a level of the distilled water in the fluid vessel.

4. The oxy-hydrogen fuel system of claim 1, wherein the fluid vessel is operatively connected at a top of the fluid vessel to an internal combustion engine for receiving oxy-hydrogen gas from the fluid vessel produced by electrolysis of the distilled water.

5. The oxy-hydrogen fuel system of claim 1, further comprising a programmable logic controller operatively connected to the pump and the power source.

6. The oxy-hydrogen fuel system of claim 5, wherein the programmable logic controller is operatively connected to an electronic control unit of an internal combustion engine.

7. An oxy-hydrogen gas generating fuel system for use by an internal combustion engine, the gas generator comprising:
a fluid vessel partially filled with distilled water;
graphene powder in the distilled water;
a fluid pump connected to the fluid vessel in a closed loop recirculation to recirculate the distilled water and suspend the graphene powder in the distilled water;
a pair of electrodes in the interior of the fluid vessel and submerged in the distilled water;
an electrical power source operatively connected to the pair of electrodes to cause electrolysis of the distilled water;
a liquid level sensor configured to detect a level of the distilled water in the fluid vessel;
an indicator light configured to indicate a level of the distilled water in the fluid vessel;
a programmable logic controller operatively connected to the pump, the power source, and an electronic control unit of an internal combustion engine; and
wherein the fluid vessel is operatively connected at a top of the fluid vessel to the internal combustion engine for the internal combustion engine to receive oxy-hydrogen gas from the fluid vessel produced by electrolysis of the distilled water.

8. A method of producing oxy-hydrogen gas for use in combustion by an internal combustion engine comprising the steps of:
providing an oxy-hydrogen gas generating fuel system having a fluid vessel containing distilled water, graphene powder in the distilled water, a fluid pump connected to the fluid vessel to circulate the distilled water, a pair of electrodes submerged in the distilled water, and power source; and
causing electrolysis of the distilled water by connecting the power source to the pair of electrodes to produce oxy-hydrogen gas in the fluid vessel.

9. The method of claim 8, further comprising the step of:
delivering the produced oxy-hydrogen gas to an internal combustion engine for use in combustion by the internal combustion engine.
